(19) United States
(12) Patent Application Publication
(10) Pub. No.: US 2009/0197533 A1
(43) Pub. Date: Aug. 6, 2009

(54) Bluetooth remote control wristwatch and related modification of bluetooth modules

(76) Inventors: Tai Wai Luk, Kowloon Bay (HK); Raymond Joseph Borowski, New Wilmington, PA (US)

Correspondence Address: RAYMOND J. BOROWSKI, 4663 NEW CASTLE ROAD, NEW WILMINGTON, PA, 16142, US

(21) Appl. No.: 12/012,740

(22) Filed: Feb. 5, 2008

(51) Int. Cl. H04B 7/00

(52) U.S. Cl. 455/41.3

(57) ABSTRACT

A Bluetooth remote control wristwatch having a means for user-input (26A and 26B) to an included non-Bluetooth transmitter/receiver (16) that wirelessly transmits the user-input to a modified Bluetooth remote control module having a non-Bluetooth transmitter/receiver (34) that receives the user-input. The Bluetooth remote control module then develops and wirelessly transmits a Bluetooth profile control signal to a Bluetooth-equipped device in accordance with the user-input at the wristwatch, thus establishing convenient and reliable wristwatch remote control of Bluetooth-equipped devices.

A time display (12), and incoming information alert (24) and display (20) on the wristwatch showing information pertinent to the Bluetooth-equipped device being controlled.

### BACKGROUND—PRIOR ART

Bluetooth technology is an ultra-low-power, short range, high frequency electronic wireless remote control system. Bluetooth technology replaces cables for remote control of numerous categories of Bluetooth-equipped devices. Bluetooth is an open technology available free to a very large number of companies around the world. Manufacturers from many industries use Bluetooth to reduce the clutter of wires, wirelessly transfer data, carry voice communication, and deliver stereo music.

Bluetooth technology was developed in Sweden in 1994. The technology takes its name from tenth century King Harald Bluetooth.

Bluetooth profiles are specific configurations of Bluetooth signals applicable to specific categories of devices. For example, Bluetooth profiles have been developed for remote control of car radios, printing and fax machines, data file transfers, medical equipment, wireless keyboard and mouse for computers, etc.

Bluetooth stereo headphone modules are a very popular application of the technology. A Bluetooth A2DP/AVRCP profile enables a Bluetooth stereo headphone module to connect wirelessly to a Bluetooth-equipped mobile phone or computer, support voice communication, adjust volume, and select and receive stereo music from the mobile phone used as an MP3 player or from the computer. A Bluetooth headphone module can be integral with the headphones or a separate module as a pendant clipped to the user's clothing and connected by wire to the headphones. User-operated buttons on the headphone module allow a user to select desired stereo music, adjust volume, and control phone calls.

A Bluetooth stereo headphone module sends wireless A2DP/AVRCP profile commands to a Bluetooth-equipped mobile phone or computer. The mobile phone or computer sends the commanded service (music, voice, data) back to the Bluetooth headphone module, thence to the headphone earphones or to a speaker connected to the module. The mobile phone can originate the communication, alerting the headphone user to an incoming phone call by a light, beeper, or vibrator on the headphone module. Caller identification, music title and artist, and FM station identification can be presented in a display window on the module. Similar procedures apply to hands-free headphones. Bluetooth A2DP/AVRCP stereo headphone modules are widely available in the market.

Bluetooth headphone remote control procedures are similar for other categories of Bluetooth remote control modules and Bluetooth-equipped devices, using Bluetooth profile commands designed specifically for the particular category of device being controlled, such as car radios, medical equipment, etc.

A problem with an integral headphone module is that the headphone is worn on the user's head and thus the buttons are not visible and are not easily and properly accessed by the user. In the case of a separate pendant module, the module is constantly changing orientation, thus requiring careful selection of the correct button to avoid unwanted large volume changes, disconnection of a phone call, or change of stereo music selection. A light on an integral headphone module or pendant module alerting the user to an incoming phone call is easily missed. A display window showing caller identification, title and artist of a music selection, or FM station identification is difficult to see even when the display is on a pendant module clipped onto the user's clothing. In some instances the short range of ultra-low-power Bluetooth profile signals can be a problem concerning distance between a Bluetooth module and a mobile phone, computer, or Bluetooth-equipped speaker.

### DRAWINGS—FIGURES

FIG. 1 shows a block diagram of components in a Bluetooth Remote Control Wristwatch.

FIG. 2 shows a representation of a Bluetooth Remote Control Wristwatch case.

FIG. 3 shows a block diagram of components in a modified Bluetooth headphone module.

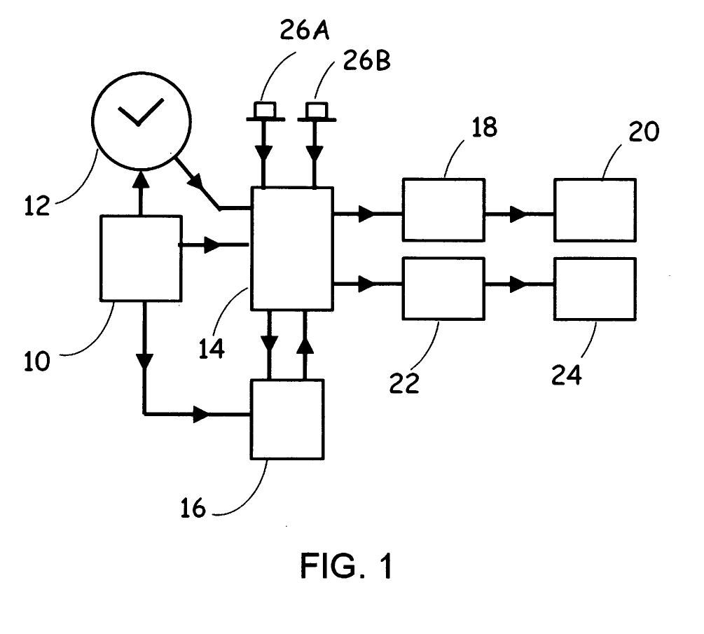

### DETAILED DESCRIPTION—FIGS. 1, 2, AND 3—PREFERRED EMBODIMENT

One embodiment of a Bluetooth remote control wristwatch and a modified Bluetooth headphone module is illustrated in FIGS. 1, 2, and 3.

In a wristwatch (FIG. 1) a battery 10 is connected to a conventional watch 12, a central control unit 14, and a non-Bluetooth wireless transmitter/receiver (transceiver) 16. User-input buttons 26A and 26B, conventional watch 12, a display unit 18, an incoming call alert unit 22, and transceiver 16 are connected to central control unit 14. An external display window 20 is connected to display unit 18. An incoming call external alert 24 is connected to incoming call alert unit 22.

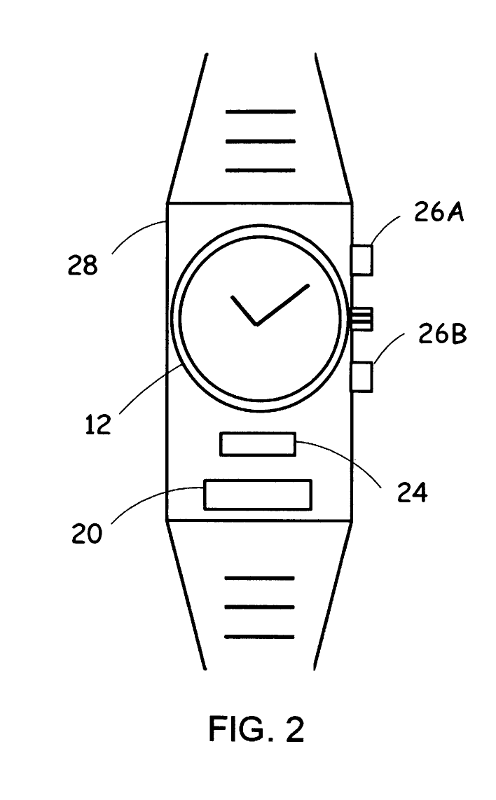

A wristwatch case 28 (FIG. 2) includes the electronic components of FIG. 1, conventional watch 12, user-input buttons 26A and 26B, external display window 20, and external alert 24. External alert 24 can be a light, beeper, vibrator, etc.

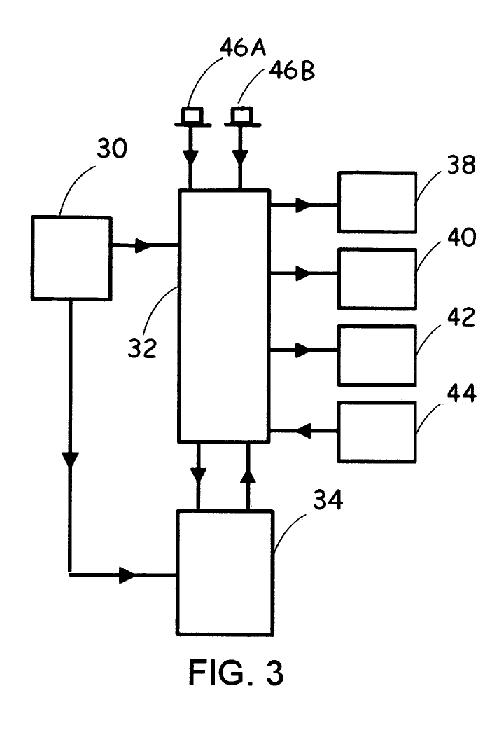

In a modified Bluetooth remote control module (FIG. 3) a battery 30 is connected to a Bluetooth A2DP/AVRCP profile unit 32, and a non-Bluetooth wireless transmitter/receiver (transceiver) unit 34. User-input buttons 46A and 46B, an optional external display 38, an optional power-on external light 40, a set of earphones or a speaker 42, and a microphone 44 are connected to Bluetooth profile unit 32.

Except for transceiver unit 34, the components in FIG. 3 are already included in a Bluetooth A2DP/AVRCP profile headphone module when it is purchased in the market. The addition of non-Bluetooth transceiver unit 34 is a complete modification of a Bluetooth A2DP/AVRCP profile headphone module.

Buttons 46A and 46B (FIG. 3) and 26A and 26B (FIGS. 1 and 2) are examples of user-input devices on a purchased Bluetooth module and on a corresponding Bluetooth remote control wristwatch. Actual user-input devices on a purchased Bluetooth module and on a corresponding Bluetooth Remote control wristwatch can be one or more buttons, slide switches, rotating knobs, etc.

### Operation—FIGS. 1, 2, 3

User-input buttons 26A and 26B on wristwatch case 28 (FIG. 2) are simply substitutes for user-input buttons 46A and 46B on a purchased Bluetooth headphone module (FIG. 3). When a button is actuated on the wristwatch case, transceiver 16 in the wristwatch (FIG. 1) broadcasts a specific non-Bluetooth signal to transceiver 34 in the modified purchased headphone module. Non-Bluetooth transceiver 16 in the wristwatch and non-Bluetooth transceiver 34 in the headphone module do not participate in Bluetooth profile signals. Non-Bluetooth signals exchanged between transceivers 16 and 34 are independent of A2DP/AVRCP profile signals generated by Bluetooth A2DP/AVRCP profile unit 32. The signals exchanged between transceivers 16 and 34 can include but are not limited to incoming call data, caller identification, music title, phonebook content, dialing list, volume setting, pause, stop, resume, etc.

A separate non-Bluetooth signal format is used for each button on the wristwatch. In the headphone module each wristwatch signal is interpreted by Bluetooth profile unit 32 as though a corresponding button was actuated on the purchased headphone module. Bluetooth profile unit 32 then generates a low power, complex, Bluetooth A2DP/AVRCP profile signal in accordance with specific button activations and broadcasts it to a Bluetooth-equipped mobile phone or computer, establishing the desired remote control operation of the mobile phone or computer.

Wristwatch incoming call alert unit 22 (FIG. 1) is activated when a Bluetooth-equipped mobile phone sends an incoming call alert signal to Bluetooth profile unit 32 (FIG. 3) in the headphone module or pendant module. Transceiver 34 (FIG. 3) sends a non-Bluetooth signal to wristwatch transceiver 16 (FIG. 1) which activates incoming call alert unit 22, and thence incoming call external alert 24 on wristwatch case 28, (FIG. 2).

Modification of the headphone module does not change the procedure for operation of the user-input buttons. Operation of user-input buttons on a modified headphone module is the same as on a purchased unmodified headphone module. Because of the corresponding button interpretation at Bluetooth profile unit 32, as mentioned above, operation of user-input buttons on the wristwatch case is likewise the same as on a purchased unmodified headphone module.

User-input buttons on the wristwatch, headphone module, or pendant module can be used for remote control of a mobile phone or computer. But only the Bluetooth remote control wristwatch provides convenience, assurance of proper operation, constant orientation, and assured visibility of the advisory information in display window 20.

### FIGS. 1, 2, 3—Alternative Embodiments

(a) As mentioned under Background-Prior Art, specific Bluetooth profile signals have been developed for remote control of various categories of equipment. Remote control modules for each category include a Bluetooth profile unit applicable specifically to only one category of equipment. Modification of remote control modules applicable to any specific category (for example, medical equipment), will add only a non-Bluetooth transceiver unit to the remote control modules (as in the headphone module of the preferred embodiment). Since non-Bluetooth signals exchanged between the wristwatch and a Bluetooth remote control module are independent of Bluetooth profile signals, a wristwatch as configured in FIGS. 1 and 2 will substitute for any category of Bluetooth profile remote control module modified only by the addition of a non-Bluetooth transceiver unit.

(b) As mentioned under Background-Prior Art, in some instances the short range of ultra-low-power Bluetooth signals can be a problem concerning distance between the Bluetooth remote control module and the Bluetooth-equipped device that is being remotely controlled. The use of a Bluetooth remote control wristwatch can effectively double the allowable distance. In the case of the preferred embodiment a Bluetooth remote control module, with a speaker attached, can be separated from the mobile phone or computer by a maximum effective distance (for example, ten meters). The wristwatch can then be separated from the Bluetooth remote control module by an additional ten meters. The person wearing the wristwatch would have remote control of music selection on the speaker from a distance of twenty meters from the mobile phone or computer. Phone calls can be similarly arranged, if required, by attaching earphones and a microphone to the Bluetooth module, with ear phone and microphone lines extending to the person wearing the wristwatch. An extended distance arrangement would be essential in any Bluetooth profile application where a possible hazard existed at or near a Bluetooth-equipped device. (For example, laboratory experiments, medical equipment, radiation hazard, etc.)

(c) Time display of conventional watch 12 can be a two or more hands (analog) display, a numerical (digital) display, or a combination of these two kinds of display. A digital time display can serve as external display window 20, showing music title, artist name, music running time, incoming call indicator, caller identification, etc., in additional to digital time.

(d) Advisory data can be displayed continuously in external display window 20, with no need for user-input commands. The advisory data can include battery level (strength), phone connection status, etc.

(e) User-input buttons 26A and 26B on wristwatch case 28 can be activated automatically through time alarm circuits connected to central control unit 14 (FIG. 1), at a selected time of day for each user-input button. This embodiment could be essential where remote control of a device must occur at an exact time of day. In a quartz conventional watch the microchip in the watch can be programmed to send various commands automatically to central control unit 14 at a selected time of day for each separate command.

(f) All the features of the Bluetooth remote control wristwatch can be included in a non-wristwatch module. This embodiment would be similar to a remote control unit used for television remote control.

### CONCLUSIONS, RAMIFICATIONS, AND SCOPE

The reader will see that the Bluetooth remote control wristwatch and related modification of Bluetooth modules provide convenience and assurance of proper operation not provided by unmodified Bluetooth modules purchased in the market.

Wristwatch communication with modified Bluetooth modules is accomplished using non-Bluetooth transceivers. No alteration is made to the complex, Bluetooth profile signals exchanged between Bluetooth remote control modules and the Bluetooth-equipped devices being remotely controlled. Non-Bluetooth modifications are well understood and reliably installed by persons having ordinary skill in the field.

The Bluetooth profile signal developed for each specific category of remotely controlled equipment (car radios, medical equipment, radiation hazard equipment, etc.), is not modified by the non-Bluetooth modification of remote control modules applicable to each category of equipment. Accordingly, wristwatch remote control of any category of Bluetooth-equipped devices is provided.

Although the description above contains many specifics, these should not be construed as limiting the scope of the embodiment but as merely providing illustrations of some of the presently preferred embodiments.

Thus, the scope of the embodiment should be determined by the appended Claims and their legal equivalents, rather than by the examples given.

We claim:

1. A Bluetooth remote control wristwatch comprising:
a time display means;
non-Bluetooth transmitter/receiver;
means for providing user-input commands to said transmitter/receiver;
incoming information alert means;
incoming information display means.

2. A modified Bluetooth remote control module comprising:
a monophonic Bluetooth headset module or stereo A2DP/AVRCP Bluetooth remote control module as available in the market;
non-Bluetooth transmitter/receiver;
whereby user-input commands transmitted by said Bluetooth remote control wristwatch of claim 1 are received and used by said modified Bluetooth remote control module to remotely control Bluetooth-equipped devices.
